(19) United States
(12) Patent Application Publication
(10) Pub. No.: US 2023/0081290 A1
(43) Pub. Date: Mar. 16, 2023

(54) DUPLEX OPERATION SYSTEM, DUPLEX OPERATION METHOD, AND PROGRAM

(71) Applicant: Nippon Telegraph and Telephone Corporation, Tokyo (JP)

(72) Inventors: Kotaro MIHARA, Musashino-shi, Tokyo (JP); Nobuhiro KIMURA, Musashino-shi, Tokyo (JP); Minoru Sakuma, Musashino-shi, Tokyo (JP); Takato TODA, Musashino-shi, Tokyo (JP)

(21) Appl. No.: 17/801,580

(22) PCT Filed: Feb. 26, 2020
(86) PCT No.: PCT/JP2020/007786

§ 371 Date: Aug. 23, 2022

(51) Int. Cl. G06F 9/455; G06F 9/4401

(52) U.S. Cl. CPC G06F 9/45558; G06F 9/4418; G06F 2009/45583; G06F 2009/45575

(57) ABSTRACT

A virtual machine control device 20 includes: an external disk 22 that has recorded thereon initialization information including user data and application software for each virtual machine 11; and a restart control unit 21 that, when a failure in which a reboot of an OS is executed without a restart escalation for expanding an initialization range in stages occurs in a virtual machine 11₀ of an active system (ACT), stops a duplexed operation, causes another general-purpose device 10ₓ to load the initialization information for the virtual machine 11₀ of an active system that has stopped and to reboot an OS and also causes a virtual machine 11₁ of a standby system (SBY) that has stopped the duplexed operation to load the initialization information for the virtual machine 11₁ and to reboot an OS, and sets as an active system the general-purpose device 10ₓ that has started up first, and sets as standby system a general-purpose device 10₁ that has started up later.

### TECHNICAL FIELD

The present invention relates to a restart method when a voice communication system, for example, is operated on a virtualization platform.

### BACKGROUND ART

In operating a voice communication system as a virtual machine (VM) on a virtualization platform, a restart escalation is performed in which an initialization range is expanded (proceeds to higher-level restart phases) in stages so as to quickly recover from a soft failure and minimize an influence on services. A target virtual machine is caused to transition to FLT after a restart escalation is performed even when a soft failure occurs due to a hardware failure. The FLT represents a fault.

For example, in Non-Patent Literature 1, a virtualization technology is disclosed that allows recovery by utilizing Auto Healing that causes automatic recovery from a failure after causing a transition to FLT (in which a target VM is deleted and is recreated on other hardware).

### CITATION LIST

### Non-Patent Literature

Non-Patent Literature 1: Takahiro Toda, and two others, “A Consideration on a Restart Method in Virtual Environment,” the Institute of Electronics, Information and Communication Engineers, 2019 General Conference, B-6-24, March 2019

### SUMMARY OF THE INVENTION

### Technical Problem

However, the conventional recovery method has a problem that even if a soft failure occurs due to a hardware failure, a restart escalation needs to be completely performed and therefore, a recovery time becomes long, causing a decrease in the reliability of a system.

The present invention has been made in view of this problem, and it is an object of the present invention to provide a duplexed operation system, a duplexed operation method, and a program that are capable of reducing a recovery time and thereby improving the reliability of the system.

### Means for Solving the Problem

One aspect of the present invention is summarized as a duplexed operation system that includes: a plurality of general-purpose devices that have a plurality of virtual machines installed thereon; and a virtual machine control device that controls duplexed operation by two systems of an active system and a standby system of the virtual machines, wherein the virtual machine control device includes: an external disk that has recorded thereon initialization information including user data and application software for each of the virtual machines; and a restart control unit that, when a failure in which a reboot of an OS is executed without a restart escalation for expanding an initialization range in stages occurs in a first one of the virtual machines which is an active system, stops the duplexed operation, causes another of the general-purpose devices to load the initialization information for the first virtual machine of an active system that has stopped and to reboot an OS and also causes a second one of the virtual machines which is a standby system that has stopped the duplexed operation to load the initialization information for the second virtual machine and to reboot an OS, and, and sets as an active system one of the general-purpose devices that has started up first and sets as a standby system one of the general-purpose devices that has started up later.

In addition, one aspect of the present invention is summarized as a duplexed operation method that is executed by the duplexed operation system described above, wherein the virtual machine control device performs a restart control step of: stopping the duplexed operation when a failure in which a reboot of an OS is executed without a restart escalation for expanding an initialization range in stages occurs in a first one of the virtual machines which is an active system; causing another of the general-purpose devices to load initialization information including user data and application software of the first virtual machine of an active system that has stopped and to reboot an OS, and also causing a second one of the virtual machines which is a standby system that has stopped the duplexed operation to load the initialization information for the second virtual machine and to reboot an OS; and setting as an active system one of the general-purpose devices that has started up first and setting as a standby system one of the general-purpose devices that has started up later.

In addition, a program according to one aspect of the present invention is summarized as a program for causing a computer to function as the duplexed operation system described above.

### Effects of the Invention

According to the present invention, a duplexed operation system, a duplexed operation method, and a program that allow a reduction of recovery time, thereby improving the reliability of the system can be provided.

### BRIEF DESCRIPTION OF DRAWINGS

FIG. 1 is a block diagram illustrating a configuration example of a duplexed operation system according to an embodiment of the present invention.

FIG. 2 is a diagram illustrating one example of a restart escalation.

FIG. 3 is a diagram schematically illustrating a process of operation of the duplexed operation system illustrated in FIG. 1.

FIG. 4 is a diagram schematically illustrating a process of operation of the duplexed operation system illustrated in FIG. 1.

FIG. 5 is a flowchart illustrating a brief procedure of the duplexed operation system illustrated in FIG. 1.

FIG. 6 is a block diagram illustrating a configuration example of a common computer system.

### DESCRIPTION OF EMBODIMENTS

Hereinafter, an embodiment of the present invention will be described with reference to drawings. The same components in a plurality of drawings are denoted by the same reference characters and description thereof will not be repeated.

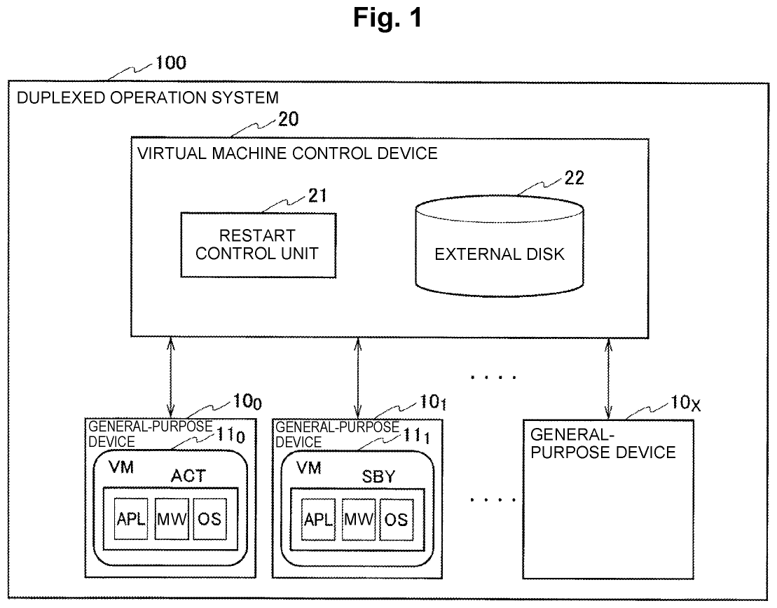

FIG. 1 is a block diagram illustrating a configuration example of a duplexed operation system according to an embodiment of the present invention. The duplexed operation system 100 illustrated in FIG. 1 includes a plurality of general-purpose devices 10₀ to 10ₓ and a virtual machine control device 20. The duplexed operation system 100 is a system that controls duplexed operation of, for example, a voice communication system. Each of the general-purpose devices 10₀ to 10ₓ is, for example, an SIP server.

As illustrated in FIG. 1, the general-purpose device 10₀ has a virtual machine 11₀ installed thereon. The general-purpose device 10₁ has a virtual machine 11₁ installed thereon. The general-purpose device 10ₓ does not have a virtual machine 11ₓ installed thereon. In the description below, when it is not necessary to specify a general-purpose device, they are represented as a “general-purpose device 10.” The same applies to a virtual machine 11.

Thus, the duplexed operation system 100 includes a plurality of general-purpose devices 10 each having a virtual machine 11 installed thereon and a plurality of general-purpose devices 10 (in FIG. 1, only one of them is illustrated for convenience of drawing) each not having a virtual machine 11 installed thereon. Note that a plurality of virtual machines 11 may be installed on one general-purpose device 10.

The general-purpose device 10 and the virtual machine control device 20 can be implemented by a computer including, for example, a ROM, RAM, and CPU. In this case, the processing contents of functions that the general-purpose device 10 and the virtual machine control device 20 should include are described by a program.

The virtual machine control device 20 includes a restart control unit 21 and an external disk 22; and controls a duplexed operation by two systems of an active system (ACT) and a standby system (SBY) of the virtual machines 11.

The external disk 22 has recorded thereon initialization information including user data and application software for each virtual machine 11. The external disk 22 is configured with, for example, a hard disk drive (HDD).

The restart control unit 21 stops the duplexed operation when a failure in which a reboot of an operating system (OS) is executed without a restart escalation for expanding an initialization range in stages occurs in a virtual machine 11 of an active system. The restart control unit 21 causes another general-purpose device 10 to load initialization information for a virtual machine 11₀ of an active system (ACT) that has stopped and to reboot an OS; and also causes a virtual machine 11₁ of a standby system (SBY) that has stopped the duplexed operation to load initialization information for the virtual machine 11₁ and to reboot an OS. The restart control unit 21 sets as an active system (ACT) a general-purpose device 10₁ that has started up first and sets as a standby system (SBY) a general-purpose device 10ₓ that has started up later.

The restart escalation refers to expanding in stages the range of reboot when a failure occurs in a voice communication system, for example, that controls the duplexed operation of the duplexed operation system 100.

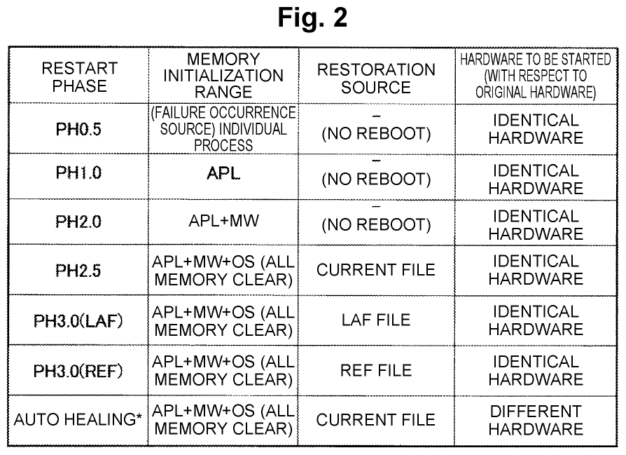

FIG. 2 is a diagram illustrating one example of a restart escalation. The first column from the left indicates each stage (restart phase) of the restart escalation. The second column indicates a memory range to be initialized. The third column indicates a location of data to be initialized. The fourth column indicates hardware to be restarted.

The PH 0.5 means an individual process reset. Only reset of an individual process on the same hardware is performed and also, a reboot is not performed.

The PH1.0 causes initialization of operation by application software. Hereinafter, application software may be referred to as app (APL). Only reset of the operation of specific app on the same hardware is performed and also, a reboot is not performed.

The PH2.0 causes initialization of operation by app and middleware. Only reset of specific app and middleware on the same hardware is performed and also, a reboot is not performed. The middleware refers to software in a layer for connection between app and an operation system (OS).

The PH2.5 causes initialization of an OS too in addition to the initialization range in the PH2.0. The PH2.5 causes the initialization by reloading of the app, MW, and OS on the same hardware; and causes a reboot of the OS. In this case, the initialization is performed by using a current file.

The PH3.0 is different from the PH2.5 in that initialization is performed by using a LAF file that is backup data which is backed up daily, for example. In addition, initialization may be performed by using a REF file that is an initial data set. Note that the PH3.0 may cause initialization by using either the LAF file or REF file. Alternatively, initialization by the REF file may be separated as a PH3.5 from that stage.

The PH0.5 to PH3.0 is initialization performed on the same hardware. If a failure is not resolved by executing the restart phase of PH3.0, Auto Healing in which a target virtual machine 11 is deleted and the virtual machine 11 is reconfigured on other hardware is executed.

Execution of initialization by performing in sequence each of the stages from PH0.5 to Auto Healing described above is a common restart escalation. Compared to this common restart escalation, restart control of the present embodiment is different in that Auto Healing is executed when a failure in which an OS is rebooted without the restart escalation described above occurs in a virtual machine 11 of an active system.

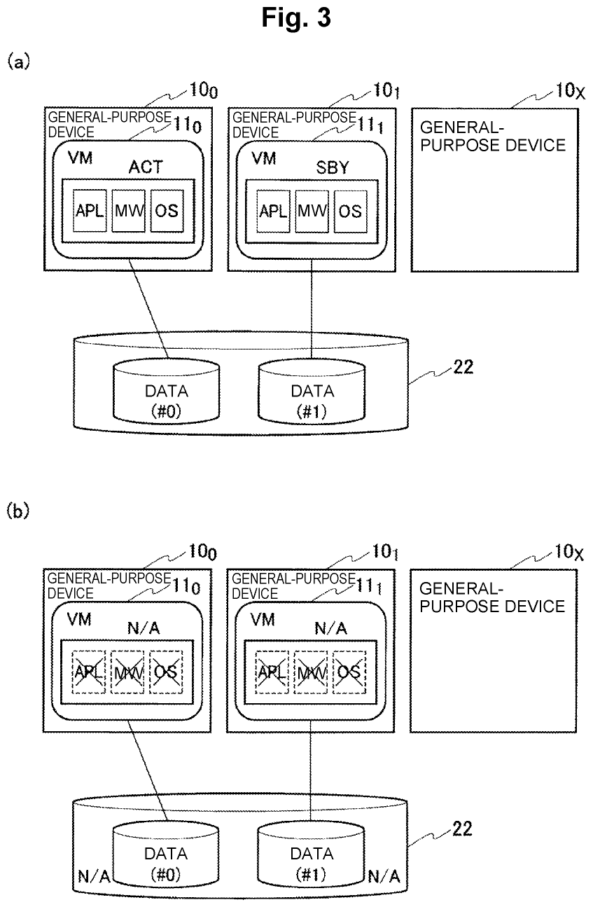

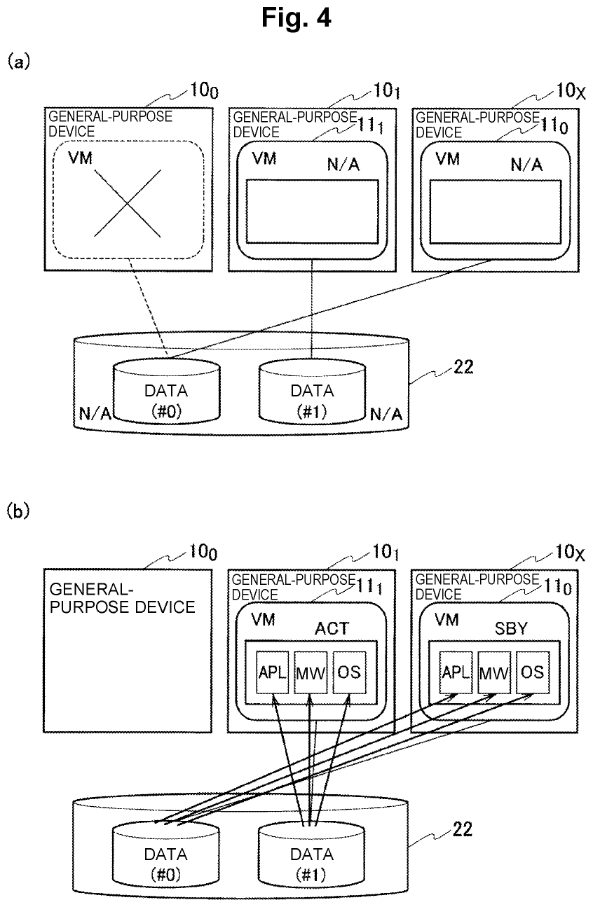

The restart control of the present embodiment will be described in detail with reference to FIG. 3 and FIG. 4. FIG. 3 and FIG. 4 are diagrams each schematically illustrating a process of operation of the duplexed operation system 100.

FIG. 3(a) is a diagram schematically illustrating a state in which the duplexed operation system 100 is performing a duplexed operation. In FIG. 3(a), the virtual machine 11₀ is operating as an active system (ACT) on hardware of the general-purpose device 10₀, and the virtual machine 11₁ is operating as a standby system (SBY) on hardware of the general-purpose device 10₁. In addition, the general-purpose device 10ₓ exists as an undefined general-purpose device that is neither an active system nor a standby system.

The virtual machine 11₁ of a standby system is stopping providing a service. However, data for the active system (#0) and data for the standby system (#1) in the external disk 22 are sequentially updated in synchronous with each other.

FIG. 3(b) is a diagram schematically illustrating a state in which a failure that requires a restart of the PH2.5 occurs and OSs are shut down. In this case, the duplexed operation is stopped; and memory that is used by the app, MW, and OS of each of the virtual machine 11₀ and the virtual machine 11₁ is immediately released. Then, PH2.5 is recorded in a restart counter (not illustrated) in the external disk 22 that corresponds to each of the virtual machines 11₀ and 11₁. “N/A” illustrated in the figure indicates a state of not operating in shutdown.

FIG. 4(a) is a diagram schematically illustrating a state in which initialization information for the virtual machine 11₀ of an active system that has stopped is loaded into, for example, the general-purpose device 10ₓ. At the same time, initialization information for the virtual machine 11₁ is loaded into the virtual machine 11₁ of a standby system.

More specifically, FIG. 4(a) illustrates a state of executing Auto Healing in which the virtual machine 11₀ is deleted from the general-purpose device 10₀ and the virtual machine 11₀ is generated on the general-purpose device 10ₓ.

FIG. 4(b) is a diagram schematically illustrating a state in which the OSs of both the devices of virtual machines 11₁ and 11₀ that have been initialized are rebooted and the virtual machine 11₁ has started up first, for example. The general-purpose device 10₁ that has started up first is set as an active system and a general-purpose device 10ₓ that has started up later is set as a standby system.

As described above, the duplexed operation system 100 of this embodiment is a duplexed operation system that includes: a plurality of general-purpose devices 10 that have a plurality of virtual machines 11 installed thereon; and a virtual machine control device 20 that controls duplexed operation by two systems of an active system (ACT) and a standby system (SBY) of the virtual machines 11. The virtual machine control device 20 includes: an external disk 22 that has recorded thereon initialization information including user data and application software for each of the virtual machines 11; and a restart control unit 21 that, when a failure in which a reboot of an OS is executed without a restart escalation for expanding an initialization range in stages occurs in an active system (ACT), stops the duplexed operation, causes another of the general-purpose devices 10ₓ to load the initialization information for a virtual machine 11₀ of the active system (ACT) that has stopped and to reboot an OS and also causes a virtual machine 11₁ of a standby system (SBY) that has stopped the duplexed operation to load initialization information for the virtual machine 11₁ and to reboot an OS, and sets as an active system (ACT) a general-purpose device 10₁ that has started up first and sets as a standby device a general-purpose device 10ₓ that has started up later. Thus, the duplexed operation system 100 of this embodiment can reduce a recovery time, thereby improving the reliability of the system.

More specifically, if a soft failure due to a hardware failure occurs first, Auto Healing is executed without performing a restart escalation. Therefore, a recovery time is reduced and thereby, the reliability of the system can be improved.

(Duplexed Operation Method)

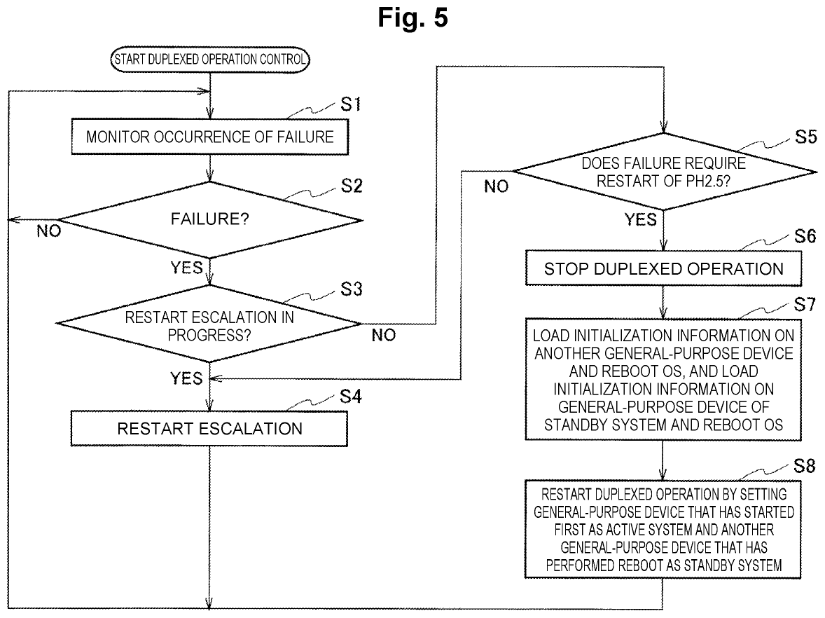

FIG. 5 is a flowchart illustrating a procedure of a duplexed operation method that is performed by the duplexed operation system 100 according to this embodiment.

When the duplexed operation system 100 starts operation, the occurrence of a failure in a general-purpose device 10 of an active system (ACT) is monitored (step S1). The monitoring of a failure is repeated until a failure is detected (step S2: NO).

If a failure in the general-purpose device 10 of an active system (ACT) is detected (step S2: YES), whether a restart escalation is in progress is determined (step S3). For example, assume a case in which a failure occurs in an individual process of the general-purpose device 10.

In this case, it is a failure at the beginning of starting a restart escalation and therefore, the restart escalation has not been started yet (step S3: NO). Therefore, a determination at step S5 is also made as NO and a restart escalation starts from PH0.5 (step S4).

After that, if the failure is resolved by the restart of PH0.5, NO at step S2 and a loop at step S1 (failure detection) are repeated. If the failure is not resolved by the restart of PH0.5, a restart escalation is performed in the order of PH1.0, PH2.0, PH2.5, PH3.0, and Auto Healing.

This process flow of the step S1, No at step S5, and step S4 is the operation of a conventional restart escalation. Therefore, description on the flow will be omitted.

The duplexed operation method according to this embodiment is different from the conventional restart method in that Auto Healing is executed in a case where a failure requiring the restart of PH2.5 occurs first (step S5: YES) like a case where NG is detected by Watch dog, for example.

If a failure requiring the restart of PH2.5 occurs (step S5: YES) in a state where a restart escalation is not being executed (step S3: NO), duplexed operation is immediately stopped (step S6).

Next, another general-purpose device is caused to load initialization information including user data and application software of a virtual machine 11₀ of an active system (ACT) that has stopped and to reboot an OS, and also, a virtual machine 11₁ of a standby system (SBY) that has stopped the duplexed operation is caused to load initialization information for the virtual machine 11₁ and to reboot an OS (step S7).

Then, a restart control step is performed in which a general-purpose device 10₁ that has started up first is set as an active system (ACT) and a general-purpose device 10ₓ that has started up later is set as a standby system (SBY) (step S8).

As described above, the duplexed operation method according to this embodiment is a duplexed operation method that is executed by a virtual machine control device 20 of a duplexed operation system including: a plurality of general-purpose devices 10 that have a plurality of virtual machines installed thereon; and the virtual machine control device 20 that controls duplexed operation by two systems of an active system (ACT) and a standby system (SBY) of the virtual machines 11. The virtual machine control device 20 performs a restart control step of: when a failure in which a reboot of an OS is executed without a restart escalation for expanding an initialization range in stages occurs in an active system (ACT), stopping the duplexed operation; causing another general-purpose device 10ₓ to load initialization information including user data and application software of a virtual machine 11₀ of the active system that has stopped and to reboot an OS, and also causing a virtual machine 11₁ of a standby system (SBY) that has stopped the duplexed operation to load initialization information for the virtual machine 11₁ and to reboot an OS; and setting as an active system (SBY) a general-purpose device 10₁ that has started up first and setting as a standby system (SBY) the general-purpose device 10ₓ that has started up later.

Thus, in the duplexed operation method according to this embodiment, a duplexed operation method capable of reducing a recovery time and thereby improving the reliability of the system can be provided.

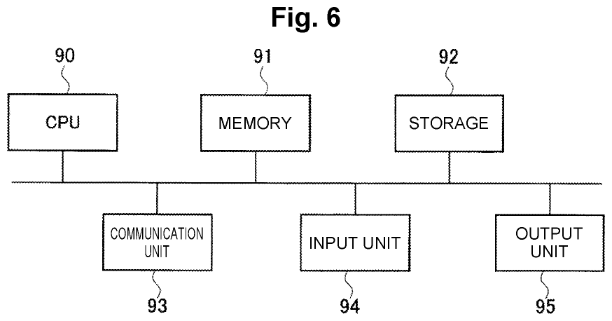

The virtual machine control device 20 and general-purpose device 10 that constitute the duplexed operation system 100 can be implemented by a common computer system illustrated in FIG. 6. For example, in a common computer system including a CPU 90, a memory 91, a storage 92, a communication unit 93, an input unit 94, and an output unit 95, each function unit of the duplexed operation system 100 is implemented by the CPU 90 executing a predetermined program loaded on the memory 91. The predetermined program can be recorded in a computer-readable recording medium such as an HDD, SSD, USB memory, CD-ROM, DVD-ROM, or MO, or can be distributed via a network. Note that each function unit of the virtual machine control device 20 may be configured with a computer system (server).

The present invention is not limited to the embodiment described above, and modifications are possible within the gist thereof. For example, description has been made by using an example in which the virtual machine control device 20 executes Auto Healing when a failure that requires the restart of PH2.5 occurs; however, the present invention is not limited thereto. Auto Healing may be executed for any failure involving a reboot of an OS. For example, Auto Healing may be executed during the PH3.0.

In addition, description has been made by using an example in which the duplexed operation system 100 of the present invention is applied to a voice communication system; however, this example is not limited thereto. The present invention can be widely applied to communication systems that communicate information other than voice.

As described above, the present invention naturally includes various embodiments not described herein. Therefore, the technical scope of the present invention is defined only by the matters specifying the invention according to the scope of claims reasonable from the above description.

### REFERENCE SIGNS LIST

100 Duplexed operation system
10 General-purpose device
11 Virtual machine
20 Virtual machine control device
21 Restart control unit
22 External disk
VM Virtual machine
ACT Active system
SBY Standby system

1. A duplexed operation system comprising:
a plurality of general-purpose devices that have a plurality of virtual machines installed thereon; and
a virtual machine control device that controls duplexed operation by two systems of an active system and a standby system of the virtual machines;
wherein the virtual machine control device includes:
an external disk that has initialization information recorded thereon, the initialization information including user data and application software for each of the virtual machines;
a processor;
a memory device storing instructions that, when executed by the processor, cause the processor to perform operations comprising:
when a failure occurs in a first one of the virtual machines, stopping the duplexed operation, the first one being an active system, the failure being such that a reboot of an OS is executed without a restart escalation, the restart escalation being for expanding an initialization range in stages;
causing another of the general-purpose devices to load the initialization information of the first virtual machine of an active system that has stopped and to reboot an OS and also causes a second one of the virtual machines, the second one being a standby system, that has stopped the duplexed operation to load the initialization information of the second virtual machine and to reboot an OS; and
setting as an active system one of the general-purpose devices that has started up first and setting as a standby system one of the general-purpose devices that has started up later.

2. A duplexed operation method executed by a virtual machine control device of a duplexed operation system, the duplexed operation system comprising:
a plurality of general-purpose devices that have a plurality of virtual machines installed thereon; and
the virtual machine control device that controls duplexed operation by two systems of an active system and a standby system of the virtual machines;
wherein the virtual machine control device performs operations comprising:
when a failure occurs in a first one of the virtual machines, stopping the duplexed operation, the first one being an active system, the failure being such that a reboot of an OS is executed without a restart escalation, the restart escalation being for expanding an initialization range in stages;
causing another of the general-purpose devices to load initialization information including user data and application software of the first virtual machine of an active system that has stopped and to reboot an OS, and also causing a second one of the virtual machines, the second one being a standby system, that has stopped the duplexed operation to load the initialization information of the second virtual machine and to reboot an OS, and
setting as an active system one of the general-purpose devices that has started up first and setting as a standby system one of the general-purpose devices that has started up later.

3. A non-transitory computer-readable medium storing software comprising instructions executable by one or more computers of a virtual machine control device of a duplexed operation system, the duplexed operation system comprising:
a plurality of general-purpose devices that have a plurality of virtual machines installed thereon; and
the virtual machine control device that controls duplexed operation by two systems of an active system and a standby system of the virtual machines;
wherein the virtual machine control device performs operations comprising:
when a failure occurs in a first one of the virtual machines, stopping the duplexed operation, the first one being an active system, the failure being such that a reboot of an OS is executed without a restart escalation, the restart escalation being for expanding an initialization range in stages;
causing another of the general-purpose devices to load initialization information including user data and application software of the first virtual machine of an active system that has stopped and to reboot an OS, and also causing a second one of the virtual machines, the second one being a standby system, that has stopped the duplexed operation to load the initialization information of the second virtual machine and to reboot an OS, and
setting as an active system one of the general-purpose devices that has started up first and setting as a standby system one of the general-purpose devices that has started up later.
